(19) United States
(12) Patent Application Publication
(10) Pub. No.: US 2015/0222454 A1
(43) Pub. Date: Aug. 6, 2015

(54) MOBILE STATION DEVICE, WIRELESS COMMUNICATION SYSTEM, CHANNEL ESTIMATION METHOD, AND PROGRAM FOR CONTROLLING SAME

(71) Applicants: NEC Corporation, Tokyo (JP); NTT DOCOMO, Inc., Tokyo (JP)

(72) Inventors: Noriyuki Shimanuki, Tokyo (JP); Toshimichi Yokote, Tokyo (JP)

(21) Appl. No.: 14/382,382

(22) PCT Filed: Feb. 21, 2013
(86) PCT No.: PCT/JP2013/055265

§ 371 Date: Sep. 2, 2014

(30) Foreign Application Priority Data
Mar. 2, 2012 (JP) 2012-046189

(51) Int. Cl. H04L 25/02

(52) U.S. Cl. CPC H04L 25/0228

(57) ABSTRACT

Provided, are a mobile station device and a channel estimation method for estimating a beam forming pattern applied in transmission beam forming processing through a forward link, thereby using a channel estimation technology having a better performance, and a control program therefor. The provided mobile station device, the channel estimation method, and the control program involve performing channel estimation processing in wireless frequency transmission through the forward link of the transmission beam forming.

### TECHNICAL FIELD

This invention relates to a mobile station device, a wireless communication system, and a channel estimation method for performing channel, estimation based on respective reference signals, and a control program for the same.

### BACKGROUND ART

In transmission beam forming, which is used in wireless communication using the orthogonal frequency division multiplex access (OFDMA) such as the Long Term Evolution (LIE) defined by the 3rd Generation Partnership Project (3GPP), a base station device (hereinafter referred to as “base station”) performs bean forming processing on a reference signal dedicated to a mobile station device (hereinafter referred to as “mobile station”) and transmission data stream (transmission data signal), and performs transmission beam forming for the mobile station. The beam forming processing is performed in units of resource blocks, each of which is obtained by bunching time and frequency direction resources in given units. The transmission beam forming herein is a technology for forming a beam while reducing interference with other mobile stations than a mobile station to/from which the base station communicates and transmitting the formed beam to the mobile station as the communication target in order to enhance reception characteristics.

The mobile station is required to perform channel estimation processing by using the dedicated reference signal in order to demodulate, data, but because the mobile station is not notified of a beam forming pattern, the mobile station cannot perform the channel estimation processing across the resource blocks. For this reason, there has been a problem in that processing is performed only for each resource block and hence the channel estimation accuracy is low and the mobile station cannot exhibit a sufficient demodulation performance.

As described above, the transmission beam forming has an advantage in that the interference can be reduced and the reception characteristics can be enhanced, but the mobile station is not notified of a beam forming pattern applied in the beam forming. Accordingly, there has been a problem in that in the case where the beam forming pattern is applied in units of resource blocks, the channel estimation required to be performed by the mobile station can be performed only in units of resource blocks, each of which uses a very small amount of resource, and hence the channel estimation accuracy is low and a sufficient demodulation performance cannot be exhibited.

In JP-A-2010-114893 (Patent Document 1). there is disclosed a user equipment device which may demodulate a data transmission using at least one common reference symbol and at least one dedicated reference symbol. To be specific, the user equipment device of Patent Document 1 constructs a first effective channel sub-matrix based on the at least one common reference symbol 402 and estimates a second effective channel sub-matrix based on the at least one dedicated reference symbol 404, thereby constructing an effective channel matrix, and the user equipment device 102 may demodulate the data transmission by using the effective channel matrix.

In wireless frequency communication through a reverse link disclosed in JP-A-2011-510599 (Patent Document 2), there is disclosed a method of channel estimation implemented in a receiver having multiple antennas configured to receive at least one common pilot available to a plurality of users and a plurality of dedicated pilots.

### PRIOR ART DOCUMENTS

### Patent Document

Patent Document 1: JP-A-2010-114893

Patent Document 2: JP-A-2011-510599

### DISCLOSURE OF THE INVENTION

### Problems to be Solved by the Invention

However, in Patent Document 1, there is merely disclosed a general configuration of the mobile station for demodulating/decoding both of the data transmission using the common reference symbol and the data transmission using the dedicated reference symbol. Further, in Patent Document 1, there, is no mention of use of the common reference symbol for the demodulation based on the dedicated reference symbol, and further, there is no mention of using the common reference symbol to acquire the channel estimation based on the dedicated reference symbol.

Further, the channel estimation method of Patent Document 2 is a channel estimation method for the base station device through the reverse link and further, it is necessary to use the dedicated reference signals received from a plurality of mobile stations, and hence there has been a problem in that the effects cannot be achieved unless the common reference signals and the dedicated reference signals are received from the plurality of mobile stations.

In view of the above, it is an object of this invention to estimate a beam forming pattern applied in transmission beam forming processing through a forward link by using a dedicated reference signal that has been subjected to beam forming processing and a common reference signal that has not been subjected to the beam forming processing, thereby increasing resources that can be used for channel estimation in frequency and time directions to enhance the performance of the channel estimation, and to further enhance a demodulation performance.

### Means to Solve the Problems

In view of the above-mentioned problems, according to one aspect of this invention, there is provided a mobile station device for performing channel estimation processing in wireless frequency transmission through a forward link of transmission beam forming, the mobile station device including: a signal separation unit for separating a signal in which a data signal, a dedicated reference signal that has been subjected to beam forming processing, and a common reference signal that has not been subjected to the beam forming processing are multiplexed; a common reference signal-use channel estimation unit for using the common reference signal separated by the signal separation unit to calculate a channel estimation value of each subcarrier; a dedicated reference signal-use zero-forcing (ZF) processing unit for using the dedicated reference signal separated by the signal separation unit to calculate a channel estimation value of each subcarrier to which the dedicated reference signal is mapped; and a beam forming pattern estimation unit for calculating a difference between the channel estimation value based on the common reference signal, which is calculated by the common reference signal-use channel estimation unit and the channel estimation value based on the dedicated reference signal which is calculated by the dedicated reference signal-use ZF processing unit, thereby estimating a beam forming pattern of each resource block.

Further, according to another aspect of this invention, there is provided a channel estimation method in wireless frequency transmission through a forward link, of transmission beam forming, the channel estimation method including: separating a signal in which a data signal, a dedicated reference signal that has been subjected to beam forming processing, and a common reference signal that has not been subjected to the beam forming processing are multiplexed; using the separated common reference signal to calculate a channel estimation value of each subcarrier; using the separated dedicated reference signal to calculate a channel estimation value of each subcarrier to which the dedicated reference signal is mapped; and calculating a difference between the channel estimation value based on the common reference signal and the channel estimation value based on the dedicated reference signal, thereby estimating a beam forming pattern of each resource block.

Further, according to another aspect of this invention, there is provided a control program for causing a computer to execute the following processing, the control program being used for performing channel estimation in wireless frequency transmission through a forward link of transmission beam forming: separating a signal in which a data signal, a dedicated reference signal that has been subjected to beam forming processing, and a common reference signal that has not been subjected to the beam forming processing are multiplexed; using the separated common reference signal to calculate a channel estimation value of each subcarrier; using the separated dedicated reference signal to calculate a channel estimation value of each subcarrier to which the dedicated reference signal is mapped; and calculating a difference between the channel estimation value based on the common reference signal and the channel estimation value based on the dedicated reference signal, thereby estimating a beam forming pattern of each resource block.

This invention has been made in order to solve the above-mentioned problems, and the common reference signals transmitted to all mobile stations within a cell are used to estimate the beam forming pattern applied in the transmission beam forming.

Further, the common reference signal is not subjected to the beam forming (preceding) processing in the transmission processing of the base station, and hence the channel, estimation value using the common reference signal includes only an element that cancels a valuation caused to the subcarrier on a propagation path. Meanwhile, the channel estimation value using the dedicated reference signal for the mobile station includes an element that cancels the variation caused on the propagation path and an influence of phase rotation and the like performed in order to give directivity in the beam forming processing. Accordingly, it is possible to estimate the beam forming pattern by calculating the difference between the channel estimation value using the common reference signal and the channel estimation value using the dedicated reference signal. When the beam forming pattern is the same, the channel estimation is not limited to the one using only each resource block and the resources that can be used for the channel estimation can be increased, and hence it is possible to enhance the channel estimation accuracy.

### Effect of the Invention

According to one embodiment of this invention, in the transmission beam forming to be used in wireless communication using the OFDMA such as the LTE, it is possible to enhance the channel estimation accuracy in the channel estimation processing performed by the mobile station in order to demodulate the channel by using not only the dedicated reference signal dedicated to each mobile station but also the common reference signal to be received in common by the mobile stations within the cell at the time of the beam forming.

Further advantages and embodiments of this invention are described in detail in the following by way of description and with reference to the drawings.

### BRIEF DESCRIPTION OF THE DRAWINGS

FIG. 1 is a block diagram illustrating an LTE, wireless communication system including a mobile station device according to an embodiment of tins invention.

FIG. 2 is a table showing a codebook to be used in preceding processing according to the embodiment of this invention.

FIG. 3 is a diagram of a time/frequency grid illustrating a sub-frame format according to the embodiment of this invention.

FIG. 4 is a diagram illustrating channel estimation values for common reference signals and channel estimation values for dedicated reference signals of a resource block according to the embodiment of this invention.

FIG. 5 is a diagram illustrating beam forming pattern estimation for each resource block according to the embodiment of this invention.

FIG. 6 is a diagram illustrating linear interpolation processing performed in a time direction in a case where a beam forming pattern estimation result is the same with respect to the same resource block according to the embodiment of this invention.

### MODE FOR EMBODYING THE INVENTION

Now, a description is given of an embodiment of this invention with reference to the drawings. Note that, the technical scope of this invention is by no means interpreted in a limitative manner by the embodiment to be described below.

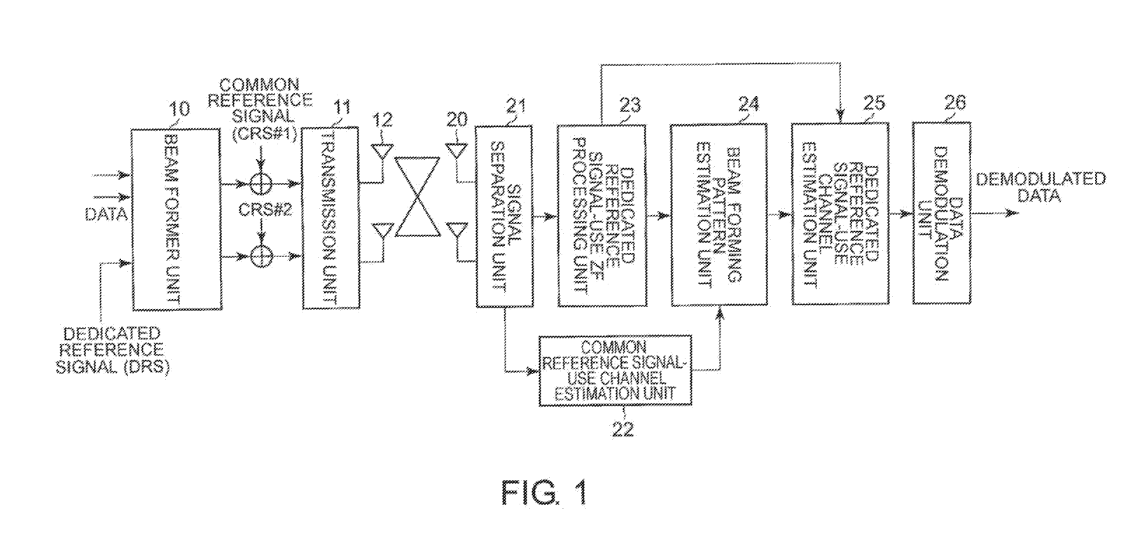

FIG. 1 is a block diagram illustrating an LTE wireless communication device (wireless communication system) according to the embodiment of this invention.

In order to perform transmission beam forming, a beam former unit 10 of a base station serving as a transmitter performs precoding processing on a data stream and a dedicated reference signal to be transmitted to a mobile station serving as a receiver in units of resource blocks. The base station then multiplexes the resultant signal and a common reference signal for each transmission antenna to be transmitted to every mobile station within a cell, and a transmission unit 11 of the base station transmits the resultant signal to the mobile station by using each of transmission antennas 12. Note that, beam forming processing based on a codebook is performed in the LTE, but the mobile station is not notified of a beam forming pattern applied on the transmission side.

Each of reception antennas 20 of the mobile station receives the signal transmitted from the base station, and a signal separation unit 21 of the mobile station converts the received signal from a time-domain signal into a frequency-domain signal, and separates the data signal, the common reference signal, and the dedicated reference signal from one another. A common reference signal-use channel estimation unit 22 of the mobile station uses the extracted common reference signal to calculate a channel estimation value of each subcarrier in order to, for example, measure quality of a propagation path. Similarly, a dedicated reference signal-use zero-forcing (dedicated reference signal-use ZF) unit 23 of the mobile station uses the dedicated reference signal to calculate a channel estimation value of each subcarrier to which the dedicated reference signal is mapped for the purpose of beam forming demodulation.

In order to improve a channel estimation accuracy for the beam forming demodulation, a beam forming pattern estimation unit 24 of the mobile station estimates the beam forming pattern applied in units of resource blocks. The common reference signal is not subjected to the preceding processing by the base station, and hence the channel estimation value based on the common reference signal includes only an element that cancels a variation caused on the propagation path. Meanwhile, the channel estimation value based on the dedicated reference signal includes an element that corrects the valuation caused on the propagation path and phase rotation given by the preceding processing. Accordingly, in regards to the channel estimation value of the subcarrier to which the dedicated reference signal is mapped, by calculating the difference between the channel estimation value based on the dedicated reference signal and the channel estimation value based on the common reference signal, it is possible to estimate the beam forming pattern for each resource block.

With use of the estimated beam forming pattern for each resource block, a dedicated reference signal-use channel estimation unit 25 of the mobile station uses the channel estimation value interpolated based on the channel estimation value calculated by the dedicated reference signal-use ZF unit 23 and the beam forming pattern to calculate the channel estimation value of every subcarrier.

The preceding is applied in units of resource blocks and the mobile station does not know its beam forming pattern, and hence the mobile station cannot perform interpolation processing and the like across the resource blocks and a problem of the channel estimation accuracy arises. Accordingly, the interpolation processing is enabled in frequency and time directions based on the beam forming pattern estimation result in units of resource blocks. In a case where the beam forming patterns can be estimated as being the same in the frequency direction, it is possible to calculate the channel estimation values for subcarriers other than the subcarriers to which the dedicated reference signals are mapped by extrapolation in the frequency direction. Further, in a case where the beam forming pattern can be estimated as being the same in the time direction, it is possible to calculate the channel estimation values by interpolation in the time direction.

A data demodulation unit 26 of the mobile station uses the channel estimation values calculated by the dedicated reference signal channel estimation unit 25 to perform data demodulation processing, to thereby acquire a demodulated data symbol.

Next, a detailed description is given of an operation of the wireless communication device according to the embodiment of this invention.

Referring to the block diagram of the embodiment illustrated in FIG. 1, a description is given of the operation by taking the transmission beam forming using an antenna port #5 of the LTE as an embodiment.

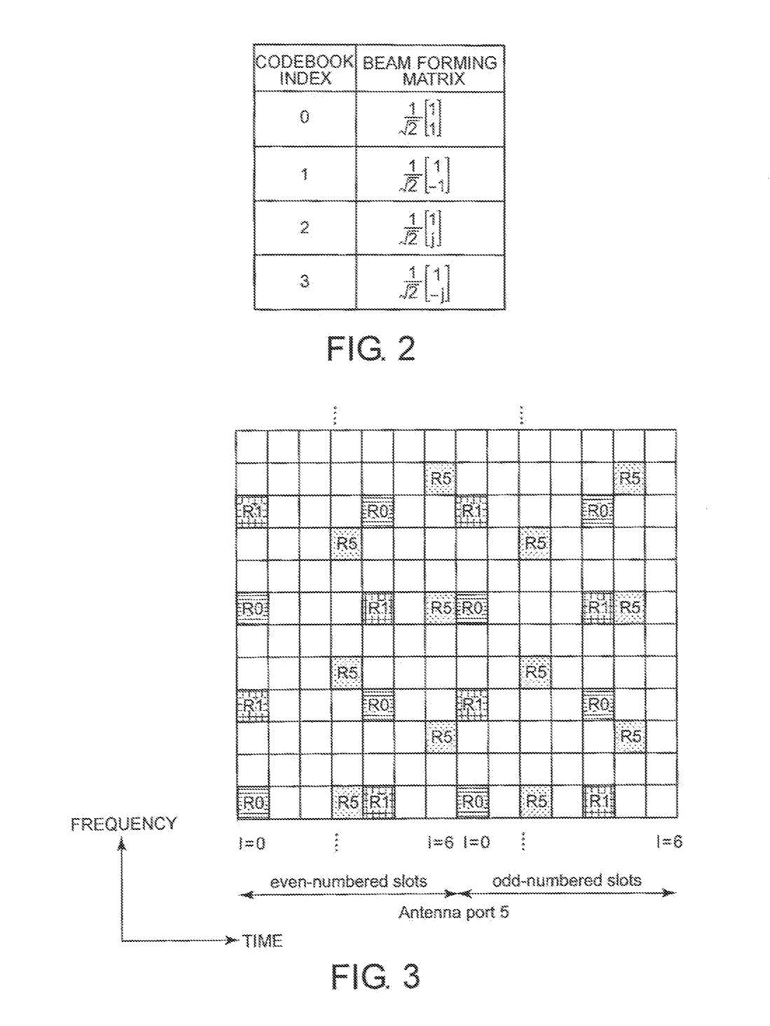

The beam former unit 10 of the base station performs the preceding processing randomly with reference to the codebook shown in FIG. 2 in units of sub-frames and in units of resource blocks, and transmits the resultant signal.

FIG. 3 is a diagram illustrating a sub-frame format in a case where a cyclic prefix (CP) is normal at the antenna port #5. It is assumed that R0 and R1 are common reference signals transmitted from an antenna port #0 and an antenna port #1, and R5 is a dedicated reference signal transmitted from the antenna port #5. Note that, it is assumed that data and the dedicated reference signals are mapped to R resource blocks.

The signal separation unit 21 of the mobile station converts the signal from a time-axis signal info a frequency-axis signal, and after that, based on the mapping positions of FIG. 3, separates the common reference signal, the dedicated reference signal, and the data signal from one another. The common reference signal-use channel estimation unit 22 of the mobile station performs zero-forcing processing on the subcarrier to which the common reference signal is mapped with a known pattern, to thereby acquire a channel estimation value Cc(r, k), where k=0, . . . K−1 (K represents the number of common reference signals for the antenna ports #0 and #1 which are included in one resource block). Further, the dedicated reference signal-use zero-forcing processing unit 23 of the mobile station performs zero-forcing processing on the subcarrier to which the dedicated reference signal is mapped with a known pattern, to thereby acquire a channel estimation value Cd(r, 1), where l=0, L−1 (L represents the number of dedicated reference signals for the antenna port #5 which are included in one resource block).

The mobile station inputs the channel estimation value Cc(r, k) calculated by the common reference signal-use channel estimation unit 22 and the channel estimation value Cd(r, 1) calculated by the dedicated reference signal-use zero-forcing processing unit 23 to the beam forming pattern estimation unit 24. The beam forming pattern estimation unit 24 calculates, for each resource block to which the data is mapped, a difference Cdiff(r), where r=0, . . . , R−1, between sums of two input, channel estimation values as in the following expression by the following Expression 1.

$$Cdiff ( r ) = {\sum }_{l = 0}^{L - 1} Cd ( r , l ) - {\sum }_{k = 0}^{K - 1} Cc ( r , k ) \qquad Expression 1$$

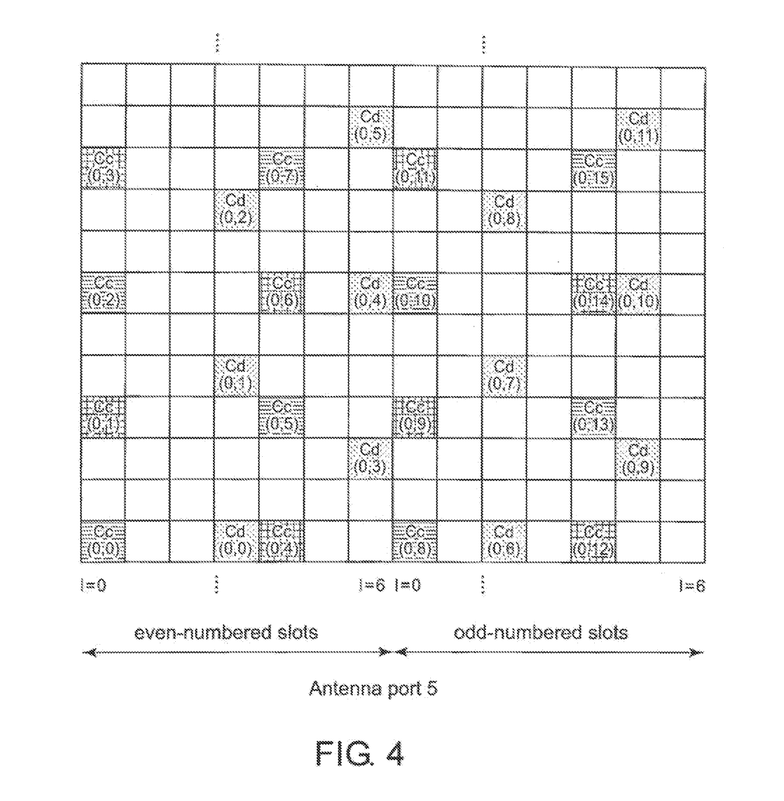

FIG. 4 illustrates the channel estimation values Cc(0, k) of the common reference signals of the resource block #0 and the channel estimation values Cd(0, 1) of the dedicated reference signals thereof. The mobile station determines a specific phase rotation amount given by one of the beam forming matrices of the codebook shown in FIG. 2 that has been used in the beam forming processing that is closest to the difference Cdiff(r) between the channel estimation values of the dedicated reference signals and the common reference signals, which has been calculated in units of resource blocks, and sets the obtained beam forming pattern estimation result as D(r), where r=0, . . . , R−1.

The dedicated reference signal-use channel estimation unit 25 of the mobile station performs the following processing based on the estimated beam forming pattern estimation results to calculate the channel estimation value of every subcarrier.

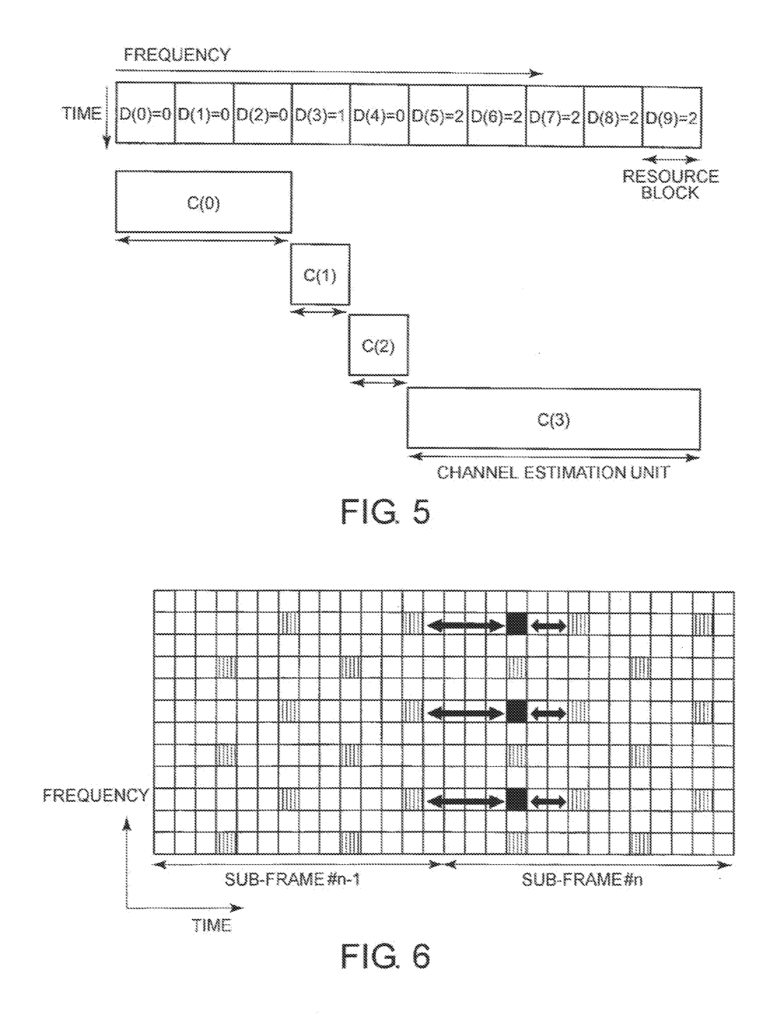

First, a description is given of processing of determining whether or not interpolation processing in the frequency direction across the resource blocks can be performed. It is determined whether or not the beam forming pattern estimation result for a resource block #1 adjacent to the resource block #0 is the same as that of the resource block #0. When those results are the same, it is determined whether or not the beam forming pattern estimation result for a resource block #2 further adjacent to the resource block #1 is the same as that of the resource block #0. This processing is performed until different beam forming patterns are obtained between adjacent resource blocks, and each set of resource blocks having the same pattern is determined as a channel estimation unit. In a case of the beam forming pattern estimation results for the respective resource blocks illustrated in FIG. 5, the patterns of tire resource blocks #0, 1, and 2 have the same pattern of “0” and the pattern of the resource block #3 is “1”, and hence the resource blocks #0, 1, and 2 are determined as one channel estimation unit. After one channel estimation unit is determined, in order to determine the next channel estimation unit, similar processing is performed until the last resource block. In the case of FIG. 5, four channel estimation units are determined. For each of the channel estimation units that has been, finally determined, the mobile station calculates the channel estimation value of every subcarrier based on the zero-forcing result by such a method as two-dimensional linear least square error interpolation.

A description is next given of interpolation determination processing in the time direction. It is assumed that in order to perform the determination processing, the mobile station holds a beam forming pattern estimation result D(n−1, r) for each resource block for a sub-frame #n−1, which has been received last before a sub-frame #n being currently received. When the beam forming pattern estimation results D(n−1, r) and D(n, r) are the same with respect to the same resource block #r, as illustrated in FIG. 6, the mobile station performs linear interpolation processing in the time direction to calculate the channel estimation values for the subcarriers which are located at the black squares. Finally, the mobile station calculates, in units of resource blocks, the channel estimation value of every subcarrier based on the zero-forcing results and the temporarily estimated values obtained by the tune interpolation by such a method as the two-dimensional linear least square error interpolation.

With use of the channel estimation value of every subcarrier estimated by the dedicated reference signal-use channel estimation unit 25, the data demodulation unit 26 of the mobile station performs the demodulation processing on the data signal to acquire the demodulated data.

As described above, this invention is capable of improving, in the wireless communication system using the transmission beam forming, the reception performance of the mobile station by enhancing the channel estimation accuracy at the mobile station. This is because this invention is capable of increasing the resources that can be used for the channel estimation by estimating the beam forming pattern in units of resource blocks which the mobile station is not notified of.

Note that, the channel estimation is performed in units of sub-frames in this embodiment, but this invention is not necessarily limited thereto and the channel estimation may also be performed in units of slots.

Further, in the transmission beam forming processing of the processing of the base station, the preceding processing based on the codebook has been described as the embodiment, but because the processing performed in the mobile station of this invention can be used as long as the mobile station can determine whether or not the directivity given in units of resource blocks is the same, this invention is not limited to the preceding processing based on the codebook, and this invention is applicable to any processing that gives the directivity in units of resource blocks.

Further, in the estimation of the beam forming pattern of this embodiment, the mobile station compares the channel estimation value of the subcarrier to winch the common reference signal is mapped and the channel estimation value of the subcarrier to which the dedicated reference signal is mapped with each other to estimate the pattern, but the mobile station may compare the subcarriers to which the dedicated reference signals are mapped with each other for estimation by using the channel estimation values obtained after the interpolation with the common reference signals.

Note that, a control program for causing a computer to execute the method of estimating a beam forming pattern according to the embodiment described above is also included in the scope of this invention. Hardware such as a control unit (CPU) is caused to operate based on the control program, thereby causing respective units of tire computer to function as respective means. Further, the control program may be recorded onto a recording medium in a fixed manner to be distributed. The program recorded onto the recording medium is read into a memory in a wired or wireless manner, or via the recording medium itself and causes the control unit and the like to operate. Note that, examples of the recording medium include an optical disc, a magnetic disk, a semiconductor memory device, and a hard disk.

This invention has been described above by way of the embodiment, but this invention is not limited to the embodiment described above. Various changes that can be understood by a person skilled in the art can be made to the configuration and details of this invention within the scope of this invention.

This application is based upon and claims the benefit of priority from Japanese patent application No. 2012-46189, filed on Mar. 2, 2012, the disclosure of which is incorporated herein in its entirety by reference.

### REFERENCES SIGNS LIST

10 beam former unit

11 transmission unit

12 transmission antenna

20 reception antenna

21 signal separation unit

22 common reference signal-use channel estimation unit

23 dedicated reference signal-use ZF processing unit

24 beam forming pattern estimation unit

25 dedicated reference signal-use channel estimation, unit

26 data demodulation unit

1. A mobile station device for performing channel estimation processing in wireless frequency transmission through a forward link of transmission beam forming, the mobile station device comprising:
a signal separation unit, for separating a signal in which a data signal, a dedicated reference signal that has been subjected to beam forming processing, and a common reference signal that has not been subjected to the beam forming processing are multiplexed;
a common reference signal-use channel estimation unit for using the common reference signal separated by the signal separation unit to calculate a channel estimation value of each subcarrier;
a dedicated reference signal-use ZF processing unit for using the dedicated reference signal separated by the signal separation unit to calculate a channel estimation value of each subcarrier to which the dedicated reference signal is mapped; and
a beam forming pattern estimation unit for calculating a difference between the channel estimation value based on the common reference signal, which is calculated by the common reference signal-use channel estimation unit, and the channel estimation value based on the dedicated reference signal, which is calculated by the dedicated reference signal-use ZF processing unit, thereby estimating a beam forming pattern of each resource block.

2. A mobile station device according to claim 1, further comprising a dedicated reference signal-use channel estimation unit for using the beam forming pattern of each resource block, and using channel estimation value interpolated based on the channel estimation value based on the dedicated reference signal, which is calculated by the dedicated reference signal-use ZF processing unit, and the beam forming pattern estimated by the beam forming pattern estimation unit to calculate the channel estimation value of every subcarrier.

3. A mobile station device according to claim 1, wherein the channel estimation value based on the common reference signal comprises an element that, cancels a variation caused to the subcarrier on a propagation path, and the channel estimation value based on the dedicated reference signal comprises an element that, cancels the variation caused on the propagation path and an influence including an influence of phase rotation performed in order to give directivity in beam forming processing.

4. A wireless communication system, comprising:
a base station device comprising:
a beam former unit for receiving a data signal and a dedicated reference signal to perform beam forming processing for each resource block; and
a transmission unit for multiplexing the data signal and dedicated reference signal that have been subjected to the beam forming processing by the beam former unit and a common reference signal to transmit the resultant signal; and
the mobile station device according to claim 1 further comprising a data demodulation unit for using the channel estimation value of every subcarrier calculated by the dedicated reference signal-use channel estimation unit to perform data demodulation processing, thereby acquiring a demodulated data symbol.

5. A channel estimation method in wireless frequency transmission through, a forward link of transmission beam forming, the channel estimation method comprising:
separating a signal in which a data signal, a dedicated reference signal that has been subjected to beam forming processing, and a common reference signal that has not been subjected to the beam forming processing are multiplexed;
using the separated common reference signal to calculate a channel estimation value of each subcarrier;
using the separated dedicated reference signal to calculate a channel estimation value of each subcarrier to which the dedicated reference signal is mapped; and
calculating a difference between the channel estimation value based on the common reference signal and the channel estimation value based on the dedicated reference signal, thereby estimating a beam forming pattern of each resource block.

6. A channel estimation method according to claim 5, further comprising using the beam forming pattern of each resource block, and using channel estimation value interpolated based on the channel estimation value based on the dedicated reference signal and the beam forming pattern to calculate the channel estimation value of every subcarrier.

7. A channel estimation method according to claim 5, wherein the channel estimation value based on the common reference signal comprises an element that cancels a variation caused to the subcarrier on a propagation path, and the channel estimation value based on the dedicated reference signal comprises an element that cancels the variation caused on the propagation path and an influence including an influence of phase rotation performed in order to give directivity in beam forming processing.

8. A channel estimation method according to claim 5, further comprising:
receiving a data signal and a dedicated reference signal to perform beam forming processing for each resource block;
multiplexing the data signal and dedicated reference signal that have been subjected to the beam forming processing and a common reference signal to transmit the resultant signal; and
using the calculated channel estimation value of every subcarrier to perform data demodulation processing, thereby acquiring a demodulated data symbol.

9. A control program for causing a computer to execute the following processing, the control program being used for performing channel estimation in wireless frequency transmission through a forward link of transmission beam forming:
separating a signal in which a data signal, a dedicated reference signal that has been subjected to beam forming processing, and a common reference signal that has not been subjected to the beam forming processing are multiplexed;
using the separated common reference signal to calculate a channel estimation value of each subcarrier;
using the separated dedicated reference signal to calculate a channel estimation value of each subcarrier to which the dedicated reference signal is mapped; and
calculating a difference between the channel estimation value based on the common reference signal and the channel estimation value based on the dedicated reference signal, thereby estimating a beam forming pattern of each resource block.

10. A mobile station device according to claim 2, wherein the channel estimation value based on the common reference signal comprises an element that cancels a variation caused to the subcarrier on a propagation path, and the channel estimation value based on the dedicated reference signal comprises an element that cancels the variation caused on the propagation path and an influence including an influence of phase rotation performed in order to give directivity in beam forming processing.

11. A wireless communication system, comprising:
a base station device comprising:
a beam former unit for receiving a data signal and a dedicated reference signal to perform beam forming processing for each resource block; and
a transmission unit for multiplexing the data signal and dedicated reference signal that have been subjected to the beam forming processing by the beam former unit and a common reference signal to transmit the resultant signal; and
the mobile station device according to claim 2 further comprising a data demodulation unit for using the channel estimation value of every subcarrier calculated by the dedicated reference signal-use channel estimation unit to perform data demodulation processing, thereby acquiring a demodulated data symbol.

12. A wireless communication system, comprising:
a base station device comprising:
a beam former unit for receiving a data signal and a dedicated reference signal to perform beam forming processing for each resource block; and
a transmission unit for multiplexing the data signal and dedicated reference signal that have been subjected to the beam forming processing by the beam former unit and a common reference signal to transmit the resultant signal; and
the mobile station device according to claim 3 further comprising a data demodulation unit for using the channel estimation value of every subcarrier calculated by the dedicated reference signal-use channel estimation unit to perform data demodulation processing, thereby acquiring a demodulated data symbol.

13. A channel estimation method according to claim 6, wherein the channel estimation value based on the common reference signal comprises an element, that, cancels a variation, caused to the subcarrier on a propagation path, and the channel estimation value based on the dedicated reference signal comprises an element that cancels the variation caused on the propagation path and an influence including an influence of phase rotation performed in order to give directivity in beam forming processing

14. A channel estimation method according to claim 6, further comprising:
receiving a data signal and a dedicated reference signal to perform beam forming processing for each resource block;
multiplexing the data signal and dedicated reference signal that have been subjected to the beam forming processing and a common reference signal to transmit the resultant signal; and
using the calculated channel estimation value of every subcarrier to perform data demodulation, processing, thereby acquiring a demodulated data symbol.

15. A channel estimation method according to claim 7, further comprising:
receiving a data signal and a dedicated reference signal to perform beam forming processing for each resource block;
multiplexing the data signal and dedicated reference signal that have been subjected to the beam forming processing and a. common reference signal to transmit the resultant signal; and
using the calculated channel estimation value of every subcarrier to perform data demodulation processing, thereby acquiring a demodulated data symbol.

16. A wireless communication system, comprising:
a base station device comprising:
a beam former unit for receiving a data signal and a dedicated reference signal to perform beam forming processing for each resource block; and
a transmission unit for multiplexing the data signal and dedicated reference signal that have been subjected to the beam forming processing by the beam former unit and a common reference signal to transmit the resultant signal; and
the mobile station device according to claim 10 further comprising a data demodulation unit for using the channel estimation value of every subcarrier calculated by the dedicated reference signal-use channel estimation unit to perform data demodulation processing, thereby acquiring a demodulated data symbol.

17. A channel estimation method according to claim 13, further comprising:
receiving a data signal and a dedicated reference signal to perform beam forming processing for each resource block;
multiplexing the data signal and dedicated reference signal that have been subjected to the beam forming processing and a common reference signal to transmit the resultant signal; and
using the calculated channel estimation value of every subcarrier to perform data demodulation processing, thereby acquiring a demodulated data symbol
